(19) United States
(12) Patent Application Publication
(10) Pub. No.: US 2011/0047303 A1
(43) Pub. Date: Feb. 24, 2011

(54) DATA TRANSFER CONTROL DEVICE AND DATA TRANSFER CONTROL METHOD

(75) Inventor: Shinya Saito, Kanagawa (JP)

Correspondence Address: YOUNG & THOMPSON, 209 Madison Street, Suite 500, Alexandria, VA, 22314, US

(73) Assignee: RENESAS ELECTRONICS CORPORATION, Kanagawa (JP)

(21) Appl. No.: 12/827,362

(22) Filed: Jun. 30, 2010

(30) Foreign Application Priority Data
Aug. 20, 2009 (JP) 2009-191046
May 12, 2010 (JP) 2010-110009

(51) Int. Cl. G06F 3/00

(52) U.S. Cl. 710/39; 710/40

(57) ABSTRACT

A data transfer control device in accordance with an exemplary aspect of the present invention includes a first communication unit that processes data transfer with a peripheral device, and a second communication unit that processes data transfer with a host device, wherein one of the first and second communication units serves as a preferential communication unit whose data transfer should have a high priority, and another of the first and second communication units serves as a non-preferential communication unit, when the data transfer is being performed in the preferential communication unit, the preferential communication unit notifies the non-preferential communication unit that the data transfer is being performed, and when the non-preferential communication unit is being notified that the data transfer is being performed from the preferential communication unit, the non-preferential communication unit puts the data transfer in the non-preferential communication unit on hold.

### INCORPORATION BY REFERENCE

This application is based upon and claims the benefit of priorities from Japanese patent application No. 2009-191046 filed on Aug. 20, 2009 and Japanese patent application No. 2010-110009 filed on May 12, 2010, the disclosures of both of which are incorporated herein in their entirety by reference.

### BACKGROUND

1. Field of the Invention

The present invention relates to a data transfer control device and a data transfer control method, in particular a data transfer control device and a data transfer control method capable of simultaneously using a host function and a peripheral function.

2. Description of Related Art

In recent years, devices equipped with USB (Universal Serial Bus) interfaces (hereinafter referred to as “USB devices”) have become widely used. Examples of USB devices that are commonly used include personal computers (hereinafter called “PCs”), printers, digital cameras, and USB memories. These USB devices are connected to other USB devices through USB interfaces, in which data transfer is performed in conformity with the USB standards. In the data transfer using USB, one device serves as a host device (e.g., a PC) and the other device serves as a peripheral device (e.g., a USB memory). The data that is transferred between these devices is temporarily stored in a buffer memory provided in a USB controller.

Meanwhile, needs for devices that support the interface standards called “OTG (USB On-The-Go)”, among the USB standards, have especially grown. In particular, in the OTG, Dual-Role Device that can have both the host function (function of operating as a host device, though the transfer rate is limited) and the peripheral function (function of operating as a peripheral device) is defined. That is, the Dual-Role Device can function as either a host device or a peripheral device. Further, if the device that is connected to the Dual-Role Device is a host device or a peripheral device supported in the conventional USB standards, the role of that Dual-Role Device is uniquely determined. That is, if the other device to which the Dual-Role Device is connected is a host device, the Dual-Role Device performs a peripheral function, whereas if the other device is a peripheral device, the Dual-Role Device performs a host function. Meanwhile, if both communication devices are Dual-Role Devices supporting the OTG standards, the decision on which device should operate as a host device is made in accordance with the standards.

Japanese Unexamined Patent Application Publication No. 2003-316728 discloses a technique relating to a data transfer control device to reduce the processing load in control transfer or to attain a similar effect in a host function. Japanese Unexamined Patent Application Publication No. 2004-349836 discloses a technique relating to a data transfer control device to increase the efficiency by performing reconstruction of pipe areas to secure respective pipe areas in the internal buffer memory. Japanese Unexamined Patent Application Publication No. 2005-122372 discloses a technique relating to a data transfer control device to achieve the effective use of the data transfer band and to reduce the power consumption. In the data transfer control device in accordance with Japanese Unexamined Patent Application Publication No. 2005-122372, when the data transfer control device receives a NAK (Negative AcKnowledgement) response, it issues a retransmission transaction after waiting a predetermined period.

### SUMMARY

Note that in the case where both a peripheral device and a host device can be connected to the above-described Dual-Role Device, the Dual-Role Device can perform both the host function and the peripheral function at the same time. In such a case, the peripheral function is performed for carrying out processing for the connected host device, while the host function is performed for carrying out processing for the connected peripheral device.

However, there is a problem that when the host function and the peripheral function are simultaneously performed in the Dual-Role Device, it is very difficult to maintain the high transfer performance of one of the functions due to the effect of the operation of the other of the functions. This is because since both the host function and the peripheral function perform data transfer with the other devices connected to the Dual-Role Device, there is a concern that the resources of the Dual-Role Device cannot be properly allocated. For example, there is a concern that when the processing load of the CPU (Central Processing Unit) that controls the Dual-Role Device is increased for the control of the peripheral function, the transfer performance of the host function could be lowered. There is another concern that when the processing load of the CPU is increased for the control of the host function on the contrary, the transfer performance of the peripheral function could be lowered.

Note that the problems to be solved in above-mentioned Japanese Unexamined Patent Application Publication Nos. 2003-316728, 2004-349836, and 2005-122372 are different from the one described above, because they do not assume the case where the host function and the peripheral function are simultaneously performed. In Japanese Unexamined Patent Application Publication No. 2003-316728, the type of transfer is limited to the control transfer and the main data transfer is not included in the intended transfer. Further, Japanese Unexamined Patent Application Publication No. 2004-349836 relates to effective use of memory areas. Furthermore, Japanese Unexamined Patent Application Publication No. 2005-122372 relates to a technique used in a host device to which a Dual-Role Device is connected.

A first exemplary aspect of the present invention is a data transfer control device including: a first communication unit that processes data transfer with a peripheral device; and a second communication unit that processes data transfer with a host device, wherein one of the first and second communication units serves as a preferential communication unit whose data transfer should have a high priority, and another of the first and second communication units serves as a non-preferential communication unit, when the data transfer is being performed in the preferential communication unit, the preferential communication unit notifies the non-preferential communication unit that the data transfer is being performed, and when the non-preferential communication unit is being notified that the data transfer is being performed from the preferential communication unit, the non-preferential communication unit puts the data transfer in the non-preferential communication unit on hold.

Another exemplary aspect of the present invention is a data transfer control method to control a data transfer control device including a first communication unit that processes data transfer with a peripheral device, and a second communication unit that processes data transfer with a host device, wherein one of the first and second communication units serves as a preferential communication unit whose data transfer should have a high priority, and another of the first and second communication units serves as a non-preferential communication unit, when the data transfer is being performed in the preferential communication unit, the preferential communication unit notifies the non-preferential communication unit that the data transfer is being performed, and when the non-preferential communication unit is being notified that the data transfer is being performed from the preferential communication unit, the non-preferential communication unit puts the data transfer in the non-preferential communication unit on hold.

With the above-described data transfer control device and the data transfer control method in accordance with the first and second aspects of the present invention, it is possible to refrain from performing data transfer by the non-preferential communication unit when data transfer is being performed with an external device by the preferential communication unit. By doing so, a larger amount of resources can be allocated to the data transfer processing in the function of the preferential communication unit. For example, when the preferential communication unit is the host function of the above-described Dual-Role Device, the transfer performance in data transfer with a peripheral device performed by the host function can be maintained at a high level. On the other hand, when the preferential communication unit is the peripheral function of the above-described Dual-Role Device, the transfer performance in data transfer with a host device performed by the peripheral function can be maintained at a high level.

The present invention can provide, in an exemplary aspect, a data transfer control device and a data transfer control method capable of maintaining the transfer performance of either one of the host function and the peripheral function at a high level when the host function and the peripheral function are simultaneously performed.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing the overall configuration of a data transfer control device in accordance with a first exemplary embodiment of the present invention;

FIG. 2 is a flowchart showing a process flow of a host controller in accordance with a first exemplary embodiment of the present invention;

FIG. 3 is a flowchart showing a process flow of a peripheral controller in accordance with a first exemplary embodiment of the present invention;

FIG. 4 is a diagram for explaining an example of a transfer status signal and a response from a peripheral control in accordance with a first exemplary embodiment of the present invention;

FIG. 5 is a diagram for explaining an example of a transfer status signal and a response from a peripheral control in accordance with a first exemplary embodiment of the present invention;

FIG. 6 is a diagram illustrating a relation between a host controller and the output of a transfer status signal in accordance with a first exemplary embodiment of the present invention;

FIG. 7 is a diagram illustrating a relation between a host controller and the output of a transfer status signal in accordance with a first exemplary embodiment of the present invention;

FIG. 8 is a block diagram showing the overall configuration of a data transfer control device in accordance with a second exemplary embodiment of the present invention;

FIG. 9 is a flowchart showing a process flow of a host controller in accordance with a second exemplary embodiment of the present invention;

FIG. 10 is a block diagram showing the overall configuration of a data transfer control device in accordance with a third exemplary embodiment of the present invention; and

FIG. 11 is a flowchart showing a process flow of a host controller or a peripheral controller in accordance with a third exemplary embodiment of the present invention.

### DETAILED DESCRIPTION OF THE EXEMPLARY EMBODIMENTS

Exemplary embodiments to which the present invention is applied are explained hereinafter in detail with reference to the drawings. The same components are denoted with the same signs throughout the drawings, and duplicated explanation of them is omitted as appropriate for clarifying the explanation.

### First Exemplary Embodiment

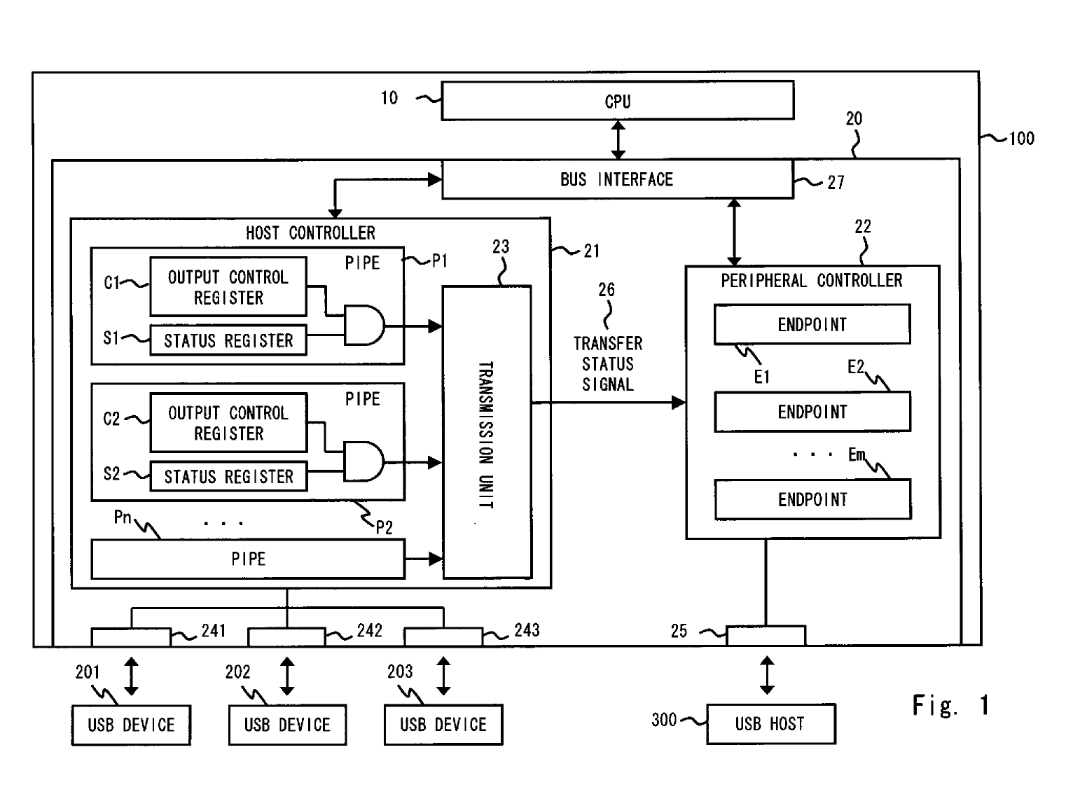

FIG. 1 is a block diagram showing the overall configuration of a data transfer control device 100 in accordance with a first exemplary embodiment of the present invention. In addition to the data transfer control device 100, USB devices 201, 202 and 203, and a USB host 300 are also illustrated in FIG. 1. The data transfer control device 100 includes a CPU 10 and a USB Dual-Role Device 20. The USB Dual-Role Device 20 is a Dual-Role Device in conformity with the USB standards. Each of the USB devices 201, 202 and 203 is a peripheral device that operates in conformity with the USB standards. Note that the number of peripheral devices is not limited to three, i.e., the USB devices 201, 202 and 203, and the only requirement is that the number of devices should be at least one. The USB host 300 is a host device that operates in conformity with USB standards.

Note that the term “data transfer” in the first exemplary embodiment in accordance with the present invention means transfer performed between the data transfer control device 100 and one of the USB devices 201, 202 and 203, or the USB host 300 based on the USB standards in which at least one USB transaction is carried out.

The data transfer control device 100 can perform a host function and a peripheral function at the same time. Note that the term “same time” in this specification is not limited to “completely same time”, but means a state where one or more USB ports are used for the host function and other USB ports are used for the peripheral function in one USB device, or the reversed state. For example, a printer may be used as a multi-function device capable of performing both the host function and the peripheral function at the same time. In such a case, the printer operates as a peripheral in a state where the printer is connected to a PC, and also operates as a host in a state where a digital camera is connected to another port of the printer. That is, when a PC and a digital camera are connected to the printer at the same time, the host function and the peripheral function are simultaneously performed.

Specific forms of use shown in FIG. 1 include a following example. In the example below, the USB device 201 is a USB memory; the USB host 300 is a PC; and the data transfer control device 100 is a printer. In this case, the data transfer control device 100 can print image data stored in the USB device 201 by a printer function. Further, the data transfer control device 100 can also print image data that is transmitted from the USB host 300 under instructions from the USB host 300. Alternatively, the data transfer control device 100 can perform the print processing of the image data stored in the USB device 201 and the print processing of the image data transmitted from the USB host 300 in an alternate manner. Note that specific examples of the data transfer control device 100, the USB device 201, and the USB host 300 are not limited to this example.

The CPU 10 controls the overall operation of the data transfer control device 100. For example, the CPU 10 reads a control program and/or set values stored in a system memory (not shown), and controls the USB Dual-Role Device 20. Further, the USB Dual-Role Device 20, which is a USB control circuit, provides an interface for the USB devices 201, 202 or 203, or the USB host 300. In this way, connections to other USB devices become possible.

Next, details of the USB Dual-Role Device 20 are explained hereinafter. The USB Dual-Role Device 20 is a device that gives a higher priority to data transfer processing in the host function in comparison to that of the peripheral function. The USB Dual-Role Device 20 includes a host controller 21, a peripheral controller 22, downstream ports 241 to 243, an upstream port 25, and a bus interface 27. The USB Dual-Role Device 20 may be implemented by, for example, an LSI (Large Scale Integration) circuit.

The downstream ports 241 to 243 are ports dedicated to the host function. By connecting one of the USB devices 201 to 203 to one of the downstream ports 241 to 243 through a USB cable, the host controller 21 can perform data transfer with the one of the USB devices 201 to 203. Note that the number of the downstream ports 241 to 243 is not limited to three, and the only requirement is that at least one downstream port should be provided.

The host controller 21 controls data transfer of one of the USB devices 201 to 203. In other words, the host controller 21 is a first communication unit that processes data transfer with one of the USB devices 201 to 203. Further, the host controller 21 is connected to the CPU 10 through the bus interface 27. Furthermore, when the host controller 21 is processing data transfer with one of the USB devices 201 to 203, the host controller 21 notifies the peripheral controller 22 that the data transfer is being processed. FIG. 1 shows a case where the host controller 21 outputs a transfer status signal 26 indicating the data transfer state between the host controller 21 and one of the USB devices 201 to 203 to the peripheral controller 22. In the following explanation, assume that the signal level of the transfer status signal 26 is at an active level when data is being transferred, and that the signal level of the transfer status signal 26 is at an inactive level when data is not being transferred. Note that the signal levels of data transfer states are not limited to this example. For example, the active level may be either “High (1)” or “Low (0)”. Note that the following explanation is made on the assumption that the active level is “1” and the inactive level is “0”. Note also that the transfer status signal 26 can be also called “transfer permission/denial signal” that is used to notify the permission/denial of the data transfer between the peripheral controller 22 and the USB host 300.

The host controller 21 includes a plurality of pipes P1, P2, . . . , and Pn, and a transmission unit 23. The pipes P1, P2, . . . , and Pn are a plurality of transfer execution units each of which performs data transfer with a respective one of a plurality of endpoints of one of the USB devices 201 to 203. Note that the number of the pipes P1, P2, . . . , and Pn is not limited to that illustrated in the figure, and may be any number equal to or smaller than a predetermined upper-limit value. Each of the pipes P1, P2, . . . , and Pn holds transfer information that is information necessary to perform data transfer, and can perform data transfer with one of the USB devices 201 to 203 through one of the downstream ports 241 to 243 based on the held transfer information. Note that the transfer information includes a total data transfer size, a maximum packet size, a transfer direction (IN or OUT), a transfer type (Control, Bulk, Interrupt, or Isochronous), and the like. However, the transfer information is not limited to this example. Note that the mechanism of data transfer based on the USB is well known, and therefore detailed explanation thereof is omitted.

The pipe P1 includes an output control register C1 and a status register S1, and the pipe P2 includes an output control register C2 and a status register S2. Similarly, the internal configuration of each of the pipes P3 (not shown), . . . , and pipe Pn is similar to that of the pipes P1 and P2, and therefore illustration and explanation thereof is omitted. Each of the status registers S1 and S2 holds a transfer status signal indicating whether or not the respective one of the pipes P1 and P2 is performing data transfer. For example, when the pipe P1 starts data transfer with one of the plurality of endpoints based on transfer information, “1” (as an example) is stored in the status register S1. Each of the output control registers C1 and C2 stores flag information used to control whether or not the transfer status signal of the respective one of the pipes P1 and P2 should be output to the transmission unit 23. For example, when the flag information stored in the output control register C1 is “1”, the value held in the status register S1 is directly output to the transmission unit 23. On the other hand, when the flag information stored in the output control register C1 is “0”, “0” (which is an example of the inactive level) is invariably output irrespective of the value of the status register S1. Note that the flag information stored in the output control register C1 or C2 can be changed from the outside at any given timing.

Then, the pipe P1 calculates the logical product of the values stored in the output control register C1 and the status register S1, and outputs the obtained value to the transmission unit 23. Similarly, the pipe P2 calculates the logical product of the values stored in the output control register C2 and the status register S2, and outputs the obtained value to the transmission unit 23.

The transmission unit 23 combines transfer status signals output from the pipes P1, P2, . . . and Pn into one transfer status signal, and outputs the one transfer status signal to the peripheral controller 22 as a transfer status signal 26 having an active level or an inactive level. The transmission unit 23 calculates the logical sum of the transfer status signals output from the pipes P1, P2, . . . , and Pn. Then, when the result of the logical sum is “1”, the transmission unit 23 brings the transfer status signal 26 to “1” level and outputs the transfer status signal 26 having “1” level to the peripheral controller 22. Further, when the transmission unit 23 calculates the logical sum of the transfer status signals output from the pipes P1, P2, . . . , and Pn and the result of the logical sum is “0”, the transmission unit 23 brings the transfer status signal 26 to “0” level and outputs the transfer status signal 26 having “0” level to the peripheral controller 22.

Further, the host controller 21 transmits a transfer status signal 26 set to an active state to the peripheral controller 22 from when data transfer with one of the USB devices 201 to 203 is started in one of the pipes P1, P2, . . . , and Pn to when the data transfer is finished in all of pipes P1, P2, . . . , and Pn that have been performing data transfer with one of the USB devices 201 to 203. In this way, the data transfer state of the host controller 21 can be efficiently conveyed to the peripheral controller 22.

Note that the transmission unit 23 does not necessarily have to combines the transfer status signals output from the pipes P1, P2, . . . , and Pn into one transfer status signal and outputs the one transfer status signal to the peripheral controller 22 as a transfer status signal 26. For example, the transmission unit 23 may output a transfer status signal to the peripheral controller 22 whenever a transfer status signal is output from the pipes P1, P2, . . . , and Pn. Then, when the peripheral controller 22 accepts any of the transfer status signals, the peripheral controller 22 may recognize that the host controller 21 is performing data transfer with the USB device 200.

Further, the above-described output control registers C1 and C2 may be implemented by a notification determination unit that determines whether or not a situation where data transfer is being performed with one of the USB devices 201 to 203 should be notified to the peripheral controller 22. In such a case, the host controller 21 transmits a transfer status signal 26 set to an active state to the peripheral controller 22 when there is at least one pipe, among pipes P1, P2, . . . , and Pn performing data transfer with one of the USB devices 201 to 203, that is determined to be notified to the peripheral controller 22 by the notification determination unit. In this way, it is possible to perform partial control on a plurality of pipes according to the degree of importance and/or the load state of the pipes. For example, in a case where simultaneous operations of the host function and the peripheral function are acceptable for data transfer in certain pipes, it is possible to prevent any unnecessary delay in data transfer of the peripheral controller 22, thus enabling efficient data transfer to be performed.

Further, when transmission to the peripheral controller 22 for which the transfer status signal 26 is brought to an active state has continued for a predetermined time or longer, the host controller 21 may bring the transfer status signal 26 to an inactive state and transmits the inactive transfer status signal 26 to the peripheral controller 22. Alternatively, the output of the transfer status signal 26 may be controlled in the transmission unit 23.

In this way, when data transfer of the host controller 21 has been preferentially performed for a predetermined time and therefore the effect on the processing of the peripheral controller 22, i.e., delay in data transfer of the peripheral controller 22 becomes excessively larger, the simultaneous operations of the host function and the peripheral function can be permitted. Further, in some cases, the transfer efficiency can be increased by relaxing the processing suppression of the peripheral controller 22. Therefore, unnecessary delay in the data transfer of the peripheral controller 22 can be prevented, thus enabling efficient data transfer to be performed.

The upstream port 25 is a port dedicated to the peripheral function. By connecting the USB host 300 to the upstream port 25 through a USB cable, the peripheral controller 22 performs data transfer between the USB host 300 and the peripheral controller 22.

The peripheral controller 22 performs data transfer with the USB host 300. In other words, the peripheral controller 22 is a second communication unit that processes data transfer with the USB host 300 Further, the peripheral controller 22 is connected to the CPU 10 through the bus interface 27.

When the peripheral controller 22 is being notified that the host controller 21 is performing data transfer with one of the USB devices 201 to 203 from the host controller 21, the peripheral controller 22 transmits a transfer disabled response indicating that data transfer cannot be performed to the USB host 300 in response to a data transfer start request from the USB host 300. In this way, even when the host function and the peripheral function are performed at the same time, the high transfer performance on the host controller 21 side can be maintained by suppressing the processing on the peripheral controller 22 side.

The peripheral controller 22 includes a plurality of endpoints E1, E2, . . . , and Em. Note that the number of the endpoints E1, E2, . . . , and Em is not limited to that illustrated in the figure, and may be any number equal to or smaller than a predetermined upper-limit value. One of the endpoints E1, E2, . . . , and Em can perform data transfer with USB host 300 through the upstream port 25. Further, the data transfer in the first exemplary embodiment in accordance with the present invention is transfer based on the USB standards. Therefore, when the peripheral controller 22 receives an IN, OUT, or PING token from the USB host 300 in bulk transfer or interrupt transfer, the peripheral controller 22 sends back a NAK (Negative AcKnowledgement) response. Note that the NAK response is merely an example of the above-described transfer disabled response.

Further, when data transfer between one of the USB devices 201 to 203 and the host controller 21 is started during data transfer between the peripheral controller 22 and the USB host 300, e.g., during a USB transaction, the peripheral controller 22 transmits a transfer disabled response in response to a data transfer start request that is sent from the USB host 300 when or after the current data transfer is completed. In this way, while the minimum necessary data transfer is maintained, any unnecessary interruption of data transfer can be prevented and the efficiency of data transfer processing can be thereby increased.

To put it in another way, the peripheral controller 22 enters a data transfer disabled mode in response to a transfer status signal 26 from the host controller 21. In the data transfer disabled mode, the peripheral controller 22 transmits a transfer disabled response in response to a data transfer start request from the USB host 300.

Further, when the transfer status signal 26 from the host controller 21 is in an active state, the peripheral controller 22 enters the data transfer disabled mode. On the other hand, when the transfer status signal 26 from the host controller 21 is in an inactive state, the peripheral controller 22 enters a mode other than the data transfer disabled mode.

Further, as described above, in the data transfer control device 100 in accordance with the first exemplary embodiment of the present invention, access processing between the peripheral function and the CPU can be restricted and therefore the overall load on the CPU can be reduced.

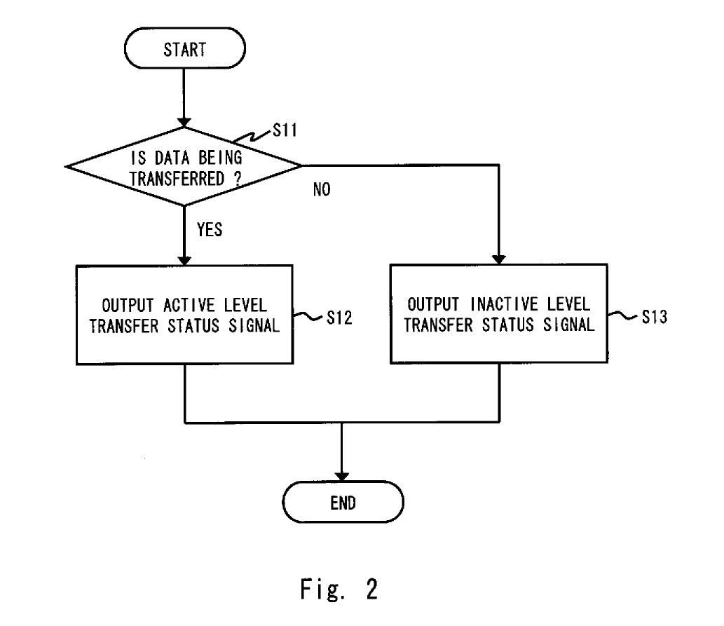

FIG. 2 is a flowchart showing a process flow of a host controller 21 in accordance with the first exemplary embodiment of the present invention. Note that in this example, assume that “1” is stored in advance in each of the output control registers C1 and C2.

Firstly, the host controller 21 determines whether data transfer is being performed or not (S11). For example, the transmission unit 23 calculates the logical sum of transfer status signals output from the pipes P1, P2, . . . , and Pn, and determines whether the result of the logical sum is “1” or not.

If the result of the logical sum is “1” in the step S11, the transmission unit 23 outputs a transfer status signal having an active level to the peripheral controller 22 (S12). For example, when data transfer between the host controller 21 and the USB device 201 is started, the pipe P1 outputs “1” to the transmission unit 23 because “1” is stored in the status register S1 and “1” is stored in advance in the output control register C1. In this case, the result of the logical sum becomes “1” irrespective of the output results from the pipes P2, . . . , and Pn. In this case, the transmission unit 23 brings the transfer status signal to “1” and outputs the transfer status signal set to “1” to the peripheral controller 22.

On the other hand, if the result of the logical sum is “0” in the step S11, the transmission unit 23 outputs a transfer status signal having an inactive level to the peripheral controller 22 (S13). For example, when data transfer is not being performed between the host controller 21 and any one of the USB devices 201 to 203, all of the output results supplied from the pipes P2, . . . , and Pn to the transmission unit 23 become “0” and the result of the logical sum also becomes “0”. In this case, the transmission unit 23 brings the transfer status signal to “0” and outputs the transfer status signal set to “0” to the peripheral controller 22.

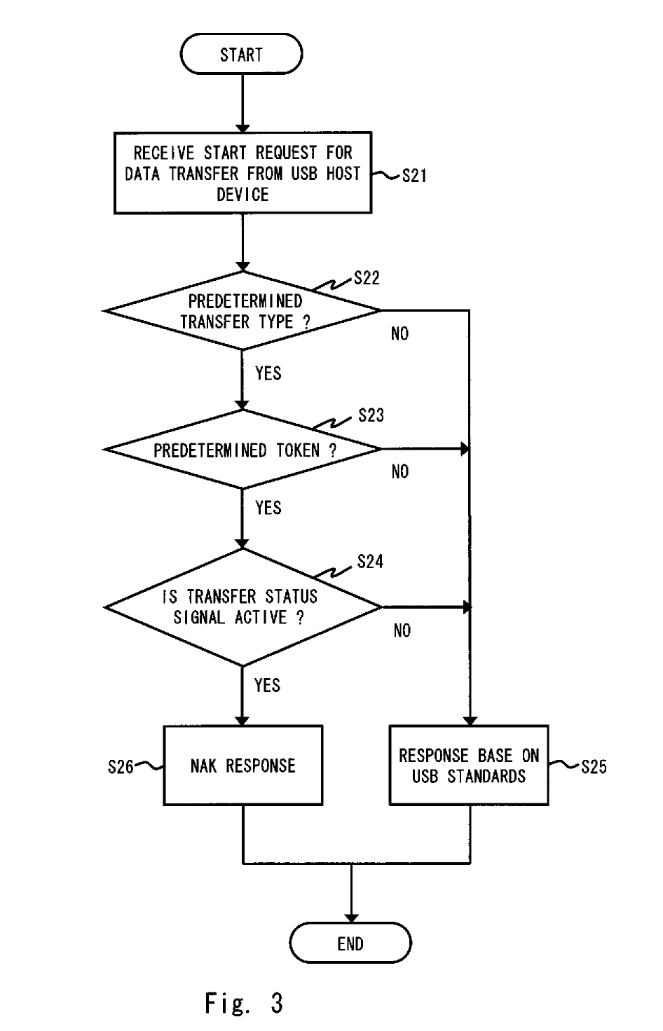

FIG. 3 is a flowchart showing a process flow of a peripheral controller 22 in accordance with the first exemplary embodiment of the present invention. Firstly, the peripheral controller 22 receives a data transfer start request from the USB host 300 (S21). For example, the endpoint E1 of the peripheral controller 22 receives a token that is a start request in control transfer, bulk transfer, interrupt transfer, or isochronous transfer from the USB host 300.

Next, the peripheral controller 22 determines whether the received start request is a predetermined transfer type or not (S22). In this example, the peripheral controller 22 determines whether or not the transfer type is one of bulk transfer and interrupt transfer. When the transfer type is neither the bulk transfer nor the interrupt transfer, i.e., when the transfer type is either control transfer or isochronous transfer, the peripheral controller 22 responds to the USB host 300 in accordance with the USB standards irrespective of the signal level of the transfer status signal 26 (S25). For example, the peripheral controller 22 responds according to the state of the internal buffer and/or of the detail of the software control.

When the transfer type is determined to be one of the bulk transfer and the interrupt transfer in the step S22, the peripheral controller 22 determines whether the start request is a predetermined token or not (S23). In this example, the peripheral controller 22 determines whether or not the start request is one of IN, OUT, and PING tokens. When the start request is determined to be a token other than IN, OUT, and PING tokens, the process proceeds to a step S25.

When the start request is determined to be one of IN, OUT, and PING tokens in the step S23, the peripheral controller 22 determines whether the transfer status signal 26 is in an active state or not (S24). In this example, the peripheral controller 22 determines whether the transfer status signal 26 received from the host controller 21 is “1” or not. When the transfer status signal 26 is determined not to be in an active state, the process proceeds to the step S25.

When the transfer status signal 26 is determined to be in an active state in the step S24, the peripheral controller 22 responds to the USB host 300 with a NAK response (S26). As a result, the data transfer between the USB host 300 and the peripheral controller 22 is temporarily put on hold.

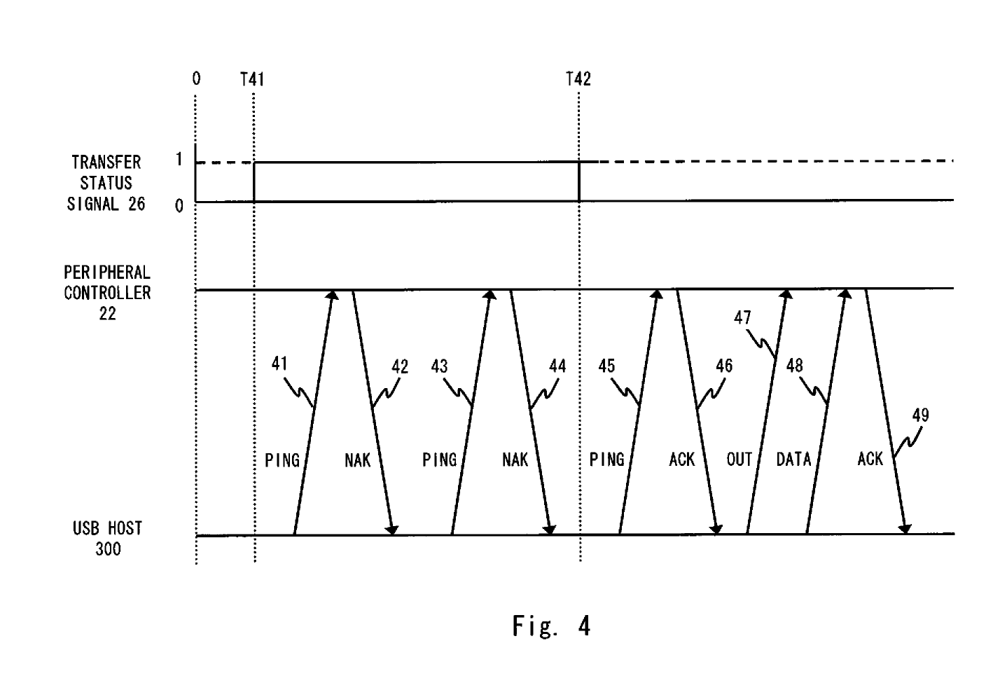

FIG. 4 is a diagram for explaining an example of a transfer status signal and a response from the peripheral controller in accordance with the first exemplary embodiment of the present invention.

In FIG. 4, firstly, the transfer status signal 26 becomes an active state between a time T41 and T42. That is, the host controller 21 outputs a transfer status signal 26 having an active level to the peripheral controller 22 at the time T41. Further, the host controller 21 outputs a transfer status signal 26 having an inactive level to the peripheral controller 22 before the time T41 and after the time T42.

Then, between the time T41 and T42, the USB host 300 transmits a PING token 41 to the peripheral controller 22. Since the transfer status signal 26 is in the active state at this point, the peripheral controller 22 transmits a NAK response 42 to the USB host 300. Similarly, the peripheral controller 22 transmits a NAK response 44 in response to a PING token 43 from the USB host 300.

Meanwhile, when the USB host 300 transmits a PING token 45 to the peripheral controller 22 after the time T42, the peripheral controller 22 transmits an ACK response 46 because the transfer status signal 26 is in the inactive state. As a result, a USB transaction is started between the peripheral controller 22 and the USB host 300. After that, the USB host 300 transmits an OUT token 47 and DATA 48 to the peripheral controller 22. Then, the peripheral controller 22 transmits an ACK response 49 to the USB host 300.

Note that although the peripheral controller 22 transmits the ACK response 46 and the ACK response 49 in response to the PING token 45 and the DATA 48 for the sake of explanation in the above-described example, the present invention is not limited to this example. That is, the peripheral controller 22 is ready for performing transfer at least after the time T42.

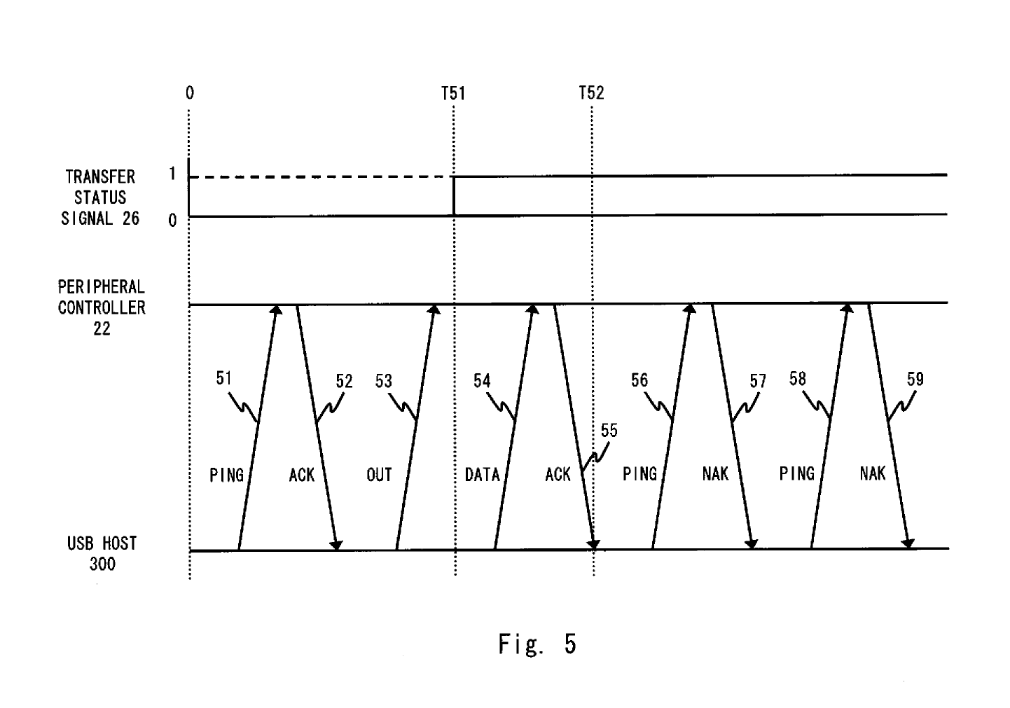

FIG. 5 is a diagram for explaining an example of a transfer status signal and a response from the peripheral controller in accordance with the first exemplary embodiment of the present invention.

In FIG. 5, the transfer status signal 26 is not in an active state from a time 0 to T51, and is in an active state after the time T51.

Firstly, when the USB host 300 transmits a PING token 51 to the peripheral controller 22 from the time 0 to T51, the peripheral controller 22 transmits an ACK response 52 because the transfer status signal 26 is not in an active state. Then, the USB host 300 transmits an OUT token 53 to the peripheral controller 22. In this way, a USB transaction is started before the time T51. Next, when the USB host 300 transmits DATA 54 to the peripheral controller 22 after the time T51, the peripheral controller 22 transmits an ACK response 55, even though the transfer status signal 26 is in the active state, because the USB transaction is already being performed.

Then, the USP transaction between the peripheral controller 22 and the USB host 300 is finished at the time T52. In this state, if the USB host 300 transmits a PING token 56 to the peripheral controller 22 after the time T52, the peripheral controller 22 transmits a NAK response 57 because the transfer status signal 26 is in the active state. Similarly, if the USB host 300 transmits a PING token 58 to the peripheral controller 22, the peripheral controller 22 transmits a NAK response 59.

Note that although the peripheral controller 22 transmits the ACK response 52 and the ACK response 55 in response to the PING token 51 and the DATA 54 for the sake of explanation in the above-described example, the present invention is not limited to this example. That is, the peripheral controller 22 is in a state where the peripheral controller 22 can perform normal transfer at least before the time T52.

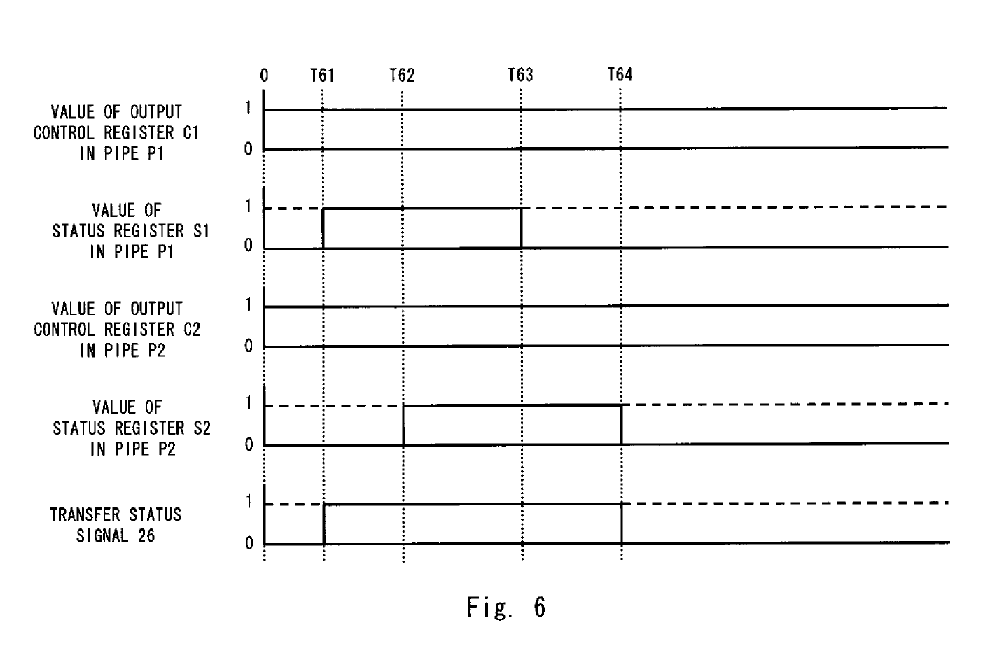

FIG. 6 is a diagram illustrating a relation between the host controller and the output of a transfer status signal in accordance with the first exemplary embodiment of the present invention. In FIG. 6, firstly, “1” is stored in advance in each of the output control register C1 of the pipe P1 and the output control register C2 of the pipe P2 at a time 0. Then, the pipe P1 starts data transfer with one of the USB devices 201 to 203 at a time T61, and “1” is thereby stored in the status register S1. As a result, the host controller 21 outputs a transfer status signal 26 set to “1” to the peripheral controller 22 at the time T61.

Next, the pipe P2 starts data transfer with one of the USB devices 201 to 203 at a time T62, and “1” is thereby stored in the status register S2. As a result, the host controller 21 outputs a transfer status signal 26 set to “1” to the peripheral controller 22 at the time T62.

Next, the pipe P1 finishes the data transfer at a time T63, and “0” is thereby stored in the status register S1. However, since both values stored in the output control register C2 and the status register S2 are “1” at the time T63, the host controller 21 maintains the output of the transfer status signal 26 to the peripheral controller 22 at “1”.

Then, the pipe P2 finishes the data transfer at a time T64, and “0” is thereby stored in the status register S2. As a result, the host controller 21 outputs a transfer status signal 26 set to “0” to the peripheral controller 22 at the time T64.

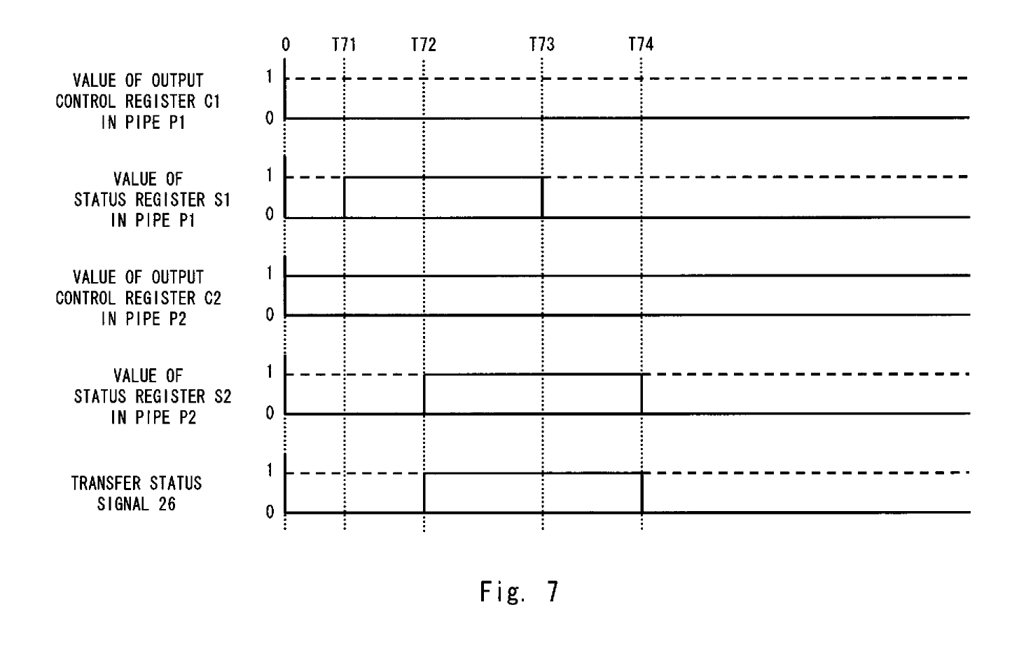

FIG. 7 is a diagram illustrating a relation between the host controller and the output of a transfer status signal in accordance with the first exemplary embodiment of the present invention. In FIG. 7, firstly, “0” is stored in advance in the output control register C1 of the pipe P1 and “1” is stored in advance in the output control register C2 of the pipe P2 at a time 0. Then, the pipe P1 starts data transfer with one of the USB devices 201 to 203 at a time T71, and “1” is thereby stored in the status register S1. However, since the value stored in the output control register C1 is “0” at the time T71, a transfer status signal set to “0” is output from the pipe P1. Therefore, the host controller 21 outputs a transfer status signal 26 set to “0” to the peripheral controller 22.

Next, the pipe P1 starts data transfer with one of the USB devices 201 to 203 at a time T72, and “1” is thereby stored in the status register S2. As a result, the host controller 21 outputs a transfer status signal 26 set to “1” to the peripheral controller 22 at the time T72.

Then, the pipe P1 finishes the data transfer at a time T73, and “0” is thereby stored in the status register S1. However, although the value stored in the output control register C1 is “0” at the time T73, the host controller 21 maintains the output of the transfer status signal 26 to the peripheral controller 22 at “1”, because both values stored in the output control register C2 and the status register S2 are “1”.

Then, the pipe P2 finishes the data transfer at a time T74, and “0” is thereby stored in the status register S2. As a result, the host controller 21 outputs a transfer status signal 26 set to “0” to the peripheral controller 22 at the time T74.

As described above, in accordance with the first exemplary embodiment of the present invention, the above-described Dual-Role Device can refrain from performing data transfer with the host device by the peripheral function when the Dual-Role Device is performing data transfer with the peripheral device by the host function. By doing so, a larger amount of resources can be allocated to the data transfer processing in the host function. Therefore, it is possible to provide a data transfer control device and a data transfer control method capable of maintaining the transfer performance of the host function at a high level when the host function and the peripheral function are simultaneously performed.

### Second Exemplary Embodiment

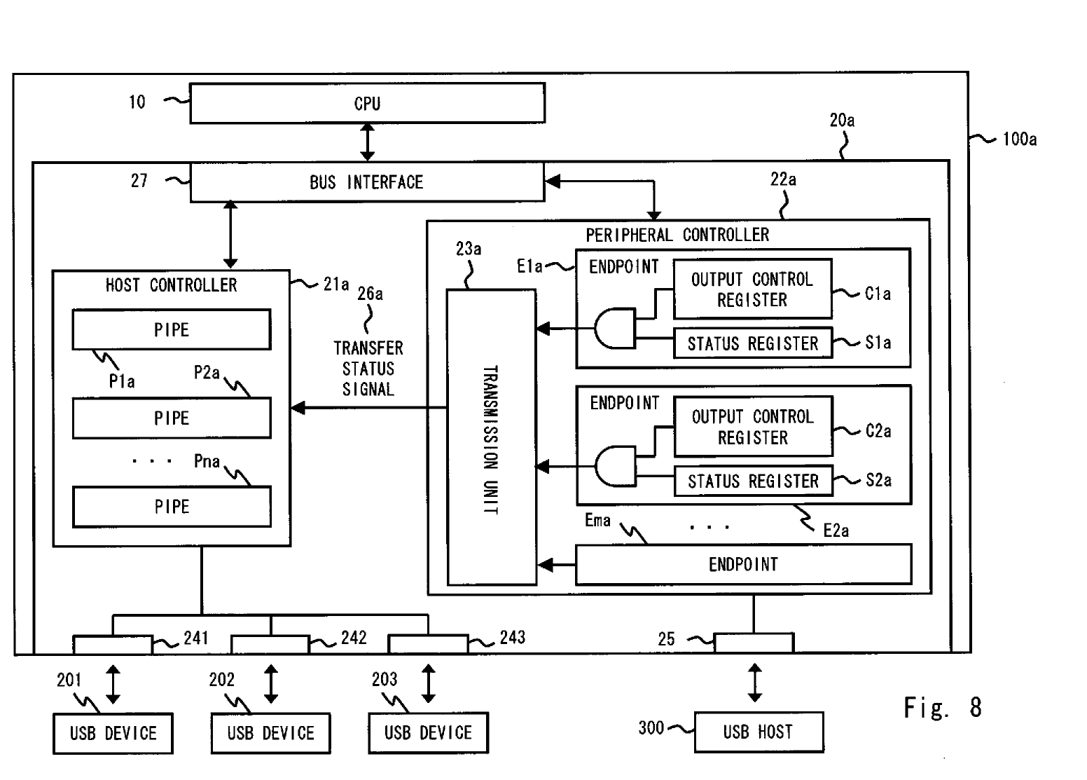

An object of the above-described first exemplary embodiment in accordance with the present invention is to improve the transfer performance of the host function. In contrast to this, a second exemplary embodiment in accordance with the present invention is aimed at cases where the transfer performance of the peripheral function is regarded as more important than that of the host function. FIG. 8 is a block diagram showing the overall configuration of a data transfer control device 100a in accordance with a second exemplary embodiment of the present invention. In FIG. 8, structures having similar functions to those of FIG. 1 are denoted by the same signs, and their detailed explanations are omitted in the following explanation. Further, the following explanation is made with particular emphasis on the differences from the first exemplary embodiment of the present invention.

As a difference from the data transfer control device 100, the data transfer control device 100a includes a USB Dual-Role Device 20a that is a Dual-Role Device in conformity with the USB standards in place of the USB Dual-Role Device 20. The USB Dual-Role Device 20a is different from the USB Dual-Role Device 20 in that the USB Dual-Role Device 20a is a device that gives a higher priority to the data transfer processing in the peripheral function in comparison to the host function. As a difference from the USB Dual-Role Device 20, the USB Dual-Role Device 20a includes a host controller 21a and a peripheral controller 22a in place of the host controller 21 and the peripheral controller 22 respectively.

When the peripheral controller 22a is processing data transfer with the USB host 300, the peripheral controller 22a notifies the host controller 21a that the data transfer is being processed. FIG. 8 shows a case where the peripheral controller 22a outputs a transfer status signal 26a indicating the data transfer state between the peripheral controller 22a and the USB host 300 to the host controller 21a. Note that the transfer status signal 26a may be an equivalent signal to the above-described transfer status signal 26. Note also that the transfer status signal 26a can be also called “transfer hold request signal” that is used to notify a request for putting data transfer between the host controller 21a and one of the USB devices 201 to 203 on hold.

The peripheral controller 22a includes a plurality of endpoints E1a, E2a, . . . , and Ema, and a transmission unit 23. Each of the endpoints E1a, E2a, . . . , and Ema performs data transfer with a respective one of a plurality of pipes of the USB host 300. Note that the number of the endpoints E1a, E2a, . . . , and Ema is not limited to that illustrated in the figure, and may be any number equal to or smaller than a predetermined upper-limit value. One of the endpoints E1a, E2a, . . . , and Ema can perform data transfer with the USB host 300 through an upstream port 25.

The endpoint E1a includes an output control register C1a and a status register S1a, and the endpoint E2a includes an output control register C2a and a status register S2a. Similarly, the internal configuration of each of the endpoint E3a (not shown), . . . , and Ema is similar to that of the endpoints E1a and E2a, and therefore illustration and explanation thereof is omitted. Each of the status registers S1a and S2a holds a transfer status signal indicating whether the respective one of the endpoints E1a and E2a is performing data transfer or not. For example, when the endpoint E1a starts data transfer with one of the plurality of pipes in response to a data transfer request from the USB host 300, “1” (as an example) is stored in the status register S1a. Each of the output control registers C1a and C2a stores flag information used to control whether or not the transfer status signal of the respective one of the endpoints E1a and E2a should be output to the transmission unit 23a. For example, when the flag information stored in the output control register C1a is “1”, the value held in the status register S1a is directly output to the transmission unit 23a. On the other hand, when the flag information stored in the output control register C1a is “0”, “0” (which is an example of the inactive level) is invariably output irrespective of the value of the status register S1a. Note that the flag information stored in the output control register C1a or C2a can be changed from the outside at any given timing.

Then, the endpoint E1a calculates the logical product of the values stored in the output control register C1a and the status register S1a, and outputs the obtained value to the transmission unit 23a. Similarly, the endpoint E2a calculates the logical product of the values stored in the output control register C2a and the status register S2a, and outputs the obtained value to the transmission unit 23a.

The transmission unit 23 combines transfer status signals output from the endpoints E1a, E2a, . . . , and Ema into one transfer status signal, and outputs the one transfer status signal to the host controller 21a as a transfer status signal 26a having an active level or an inactive level. The transmission unit 23a calculates the logical sum of the transfer status signals output from the endpoints E1a, E2a, . . . , and Ema. Then, when the result of the logical sum is “1”, the transmission unit 23a brings the transfer status signal 26a to “1” level and outputs the transfer status signal 26a having “1” level to the host controller 21a. Further, when the transmission unit 23a calculates the logical sum of the transfer status signals output from the endpoints E1a, E2a, . . . , and Ema and the result of the logical sum is “0”, the transmission unit 23a brings the transfer status signal 26a to “0” level and outputs the transfer status signal 26a having “0” level to the host controller 21a.

Note that the flag stored in the status register S1a or S2a is held in that status register until the peripheral controller 22a transmits a handshake packet to the USB host 300. Similarly, the transmission unit 23a holds the output of the transfer status signal 26a until the peripheral controller 22a transmits the handshake packet to the USB host 300.

Further, the peripheral controller 22a transmits a transfer status signal 26a set to an active state to the host controller 21a from when data transfer with the USB host 300 is started in one of the endpoints E1a, E2a, . . . , and Ema to when the data transfer is finished in all of endpoints E1a, E2a, . . . , and Ema that have been performing data transfer with the USB host 300. In this way, the data transfer state of the peripheral controller 22a can be efficiently conveyed to the host controller 21a.

Note that the transmission unit 23a does not necessarily have to combines the transfer status signals output from the endpoints E1a, E2a, . . . , and Ema into one transfer status signal and outputs the one transfer status signal to the host controller 21a as a transfer status signal 26a. For example, the transmission unit 23a may output a transfer status signal to the host controller 21a whenever a transfer status signal is output from the endpoints E1a, E2a, . . . , and Ema. Then, when the host controller 21a accepts any of the transfer status signals, the host controller 21a may recognize that the peripheral controller 22a is performing data transfer with the USB host 300.

Further, the above-described output control registers C1a and C2a may be implemented by a notification determination unit that determines whether or not a situation where data transfer is being performed with the USB host 300 should be notified to the host controller 21a. In such a case, the peripheral controller 22a transmits a transfer status signal 26a set to an active state to the host controller 21a when there is at least one endpoint, among endpoints E1a, E2a, . . . , and Ema performing data transfer with the USB host 300, that is determined to be notified to the host controller 21a by the notification determination unit. In this way, it is possible to perform partial control on a plurality of endpoints according to the degree of importance and/or the load state of the endpoints. For example, in a case where simultaneous operations of the host function and the peripheral function are acceptable for data transfer in certain endpoints, it is possible to prevent any unnecessary delay in data transfer of the host controller 21a, thus enabling efficient data transfer to be performed.

Further, when transmission to the host controller 21a for which the transfer status signal 26a is brought to an active state has continued for a predetermined time or longer, the peripheral controller 22a may brings the transfer status signal 26a to an inactive state and transmits the inactive transfer status signal 26a to the host controller 21a. Alternatively, the output of the transfer status signal 26a may be controlled in the transmission unit 23a.

In this way, when data transfer of the peripheral controller 22a has been preferentially performed for a predetermined time and therefore the effect on the processing of the host controller 21a, i.e., delay in data transfer of the host controller 21a becomes excessively larger, the simultaneous operations of the host function and the peripheral function can be permitted. Further, in some cases, the transfer efficiency can be increased by relaxing the processing suppression of the host controller 21a. Therefore, unnecessary delay in the data transfer of the host controller 21a can be prevented, thus enabling efficient data transfer to be performed.

When the host controller 21a is being notified that the peripheral controller 22a is performing data transfer with the USB host 300 from the peripheral controller 22a, the host controller 21a puts the transmission of a data transfer start request to the USB devices 201 to 203 on hold. Then, after the peripheral controller 22a has finished the data transfer with the USB host 300, the host controller 21a transmits the data transfer start request that was put on hold to one of the USB devices 201 to 203. In this way, when the host function and the peripheral function are performed at the same time, the high transfer performance on the peripheral controller 22a side can be maintained by suppressing the processing on the host controller 21a side. Note that unlike the host controller 21, the host controller 21a may not output the transfer status signal 26a to the peripheral controller 22a.

The host controller 21a includes a plurality of pipes P1a, P2a, . . . , Pna. Note that the number of the pipes P1a, P2a, . . . , Pna is not limited to that illustrated in the figure, and may be any number equal to or smaller than a predetermined upper-limit value. Each of the pipes P1a, P2a, . . . , and Pna holds transfer information that is information necessary to perform data transfer, and can perform data transfer with one of the USB devices 201 to 203 through one of the downstream ports 241 to 243 based on the held transfer information. Further, the data transfer in the second exemplary embodiment in accordance with the present invention is transfer based on the USB standards, and the host controller 21a puts the transmission of a data transfer start request on hold in bulk transfer or control transfer. With regard to pipes that perform interrupt and isochronous transfer, since periodicity is to be maintained, the host controller 21 performs not only the current transaction but also the subsequent transaction(s) even when an active transfer status signal 26a is input to the host controller 21a.

Further, when data transfer between the USB host 300 and the peripheral controller 22a is started during data transfer between the host controller 21a and one of the USB devices 201 to 203, e.g., during a USB transaction, the host controller 21a puts the transmission of a data transfer start request to the USB devices 201 to 203 that is to be performed when or after the current data transfer is completed on hold. In this way, while the minimum necessary data transfer is maintained, any unnecessary interruption of data transfer can be prevented and the efficiency of data transfer processing can be thereby increased.

To put it in another way, the host controller 21a enters a data transfer hold mode in response to the transfer status signal 26a from the peripheral controller 22a. In the data transfer hold mode, the host controller 21a puts the transmission of a data transfer start request to the USB devices 201 to 203 on hold.

Further, when the transfer status signal 26a from the peripheral controller 22a is in an active state, the host controller 21a enters the data transfer hold mode. On the other hand, when the transfer status signal 26a from the peripheral controller 22a is in an inactive state, the host controller 21a enters a mode other than the data transfer hold mode.

That is, when the host controller 21a recognizes an active transfer status signal 26a while the host controller 21a is communicating with one of the USB devices 201 to 203, the host controller 21a suspends, after the current transaction is completed, the communication with the one of the USB devices 201 to 203 from the subsequent transaction. Then, when the host controller 21a recognizes that the transfer status signal 26a becomes an inactive state, i.e., when the transfer hold mode is cancelled, the suspended data transfer is started.

Further, as described above, in the data transfer control device 100a in accordance with the second exemplary embodiment of the present invention, access processing between the host function and the CPU can be restricted and therefore the overall load on the CPU can be reduced. That is, in accordance with the second exemplary embodiment of the present invention, when the transfer performance of the peripheral function is regarded as more important than that of the host function in a system in which the host function and the peripheral function are performed at the same time, the deterioration in the transfer performance of the peripheral function can be prevented by suspending the operation of the host function during the operation of the peripheral function.

Note that the process flow to determine whether or not the transfer status signal 26a should be output or not in the peripheral controller 22a in accordance with the second exemplary embodiment of the present invention is similar to that explained with FIG. 2, provided that the host controller 21 is replaced with the peripheral controller 22a. Therefore, its illustration and explanation are omitted.

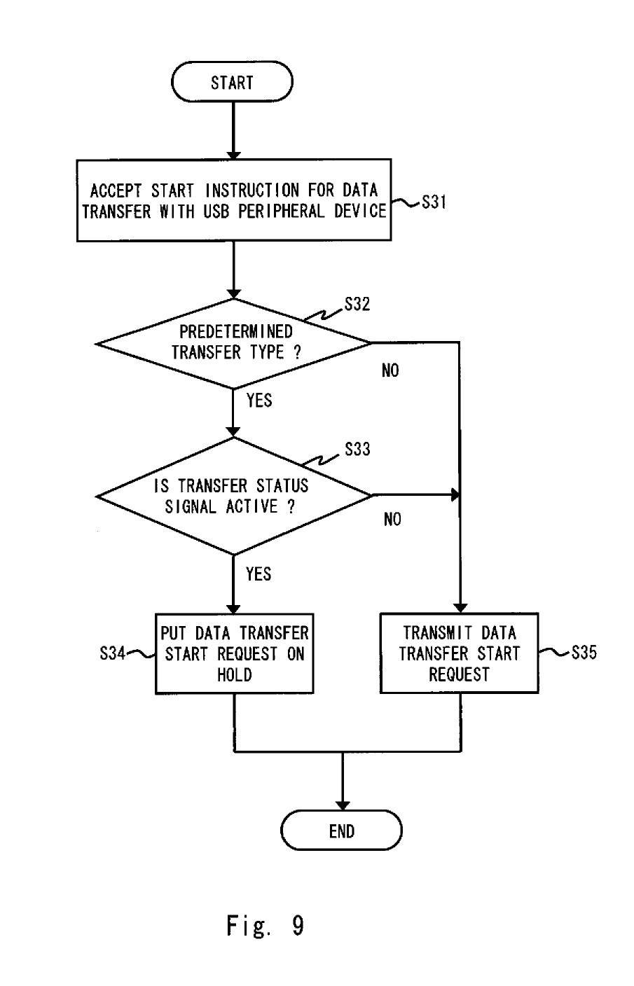

FIG. 9 is a flowchart showing a process flow of a host controller 21a in accordance with the second exemplary embodiment of the present invention. Firstly, the host controller 21a accepts a start instruction for data transfer with one of the USB devices 201 to 203 from the outside (S31). For example, the host controller 21a accepts a data transfer start instruction from a user as the user operates the data transfer control device 100a.

Next, the host controller 21a determines whether the accepted start instruction is a predetermined transfer type or not (S32). In this example, the host controller 21a determines whether or not the transfer type is one of bulk transfer and control transfer. When the transfer type is neither the bulk transfer nor the control transfer, i.e., when the transfer type is either interrupt transfer or isochronous transfer, the host controller 21a transmits a data transfer start request to one of the USB devices 201 to 203 in accordance with the USB standards irrespective of the signal level of the transfer status signal 26a (S35). For example, the host controller 21a performs a normal operation according to the state of the internal buffer and/or of the detail of the software control.

When the transfer type is determined to be one of the bulk transfer and control transfer in the step S32, the host controller 21a determines whether the transfer status signal 26a is an active state or not (S33). In this example, the host controller 21a determines whether the transfer status signal 26a received from the peripheral controller 22a is “1” or not.

When the transfer status signal 26 is determined to be in an active state in the step S33, the host controller 21a puts the data transfer start request to the USB devices 201 to 203 on hold (S34). As a result, the data transfer between the USB devices 201 to 203 and the host controller 21a is temporarily put on hold.

When the transfer status signal 26a is determined not to be in an active state in the step S33, the process proceeds to the step S35. At this point, if there is any data transfer start request that was put on hold in the step S34, the host controller 21a transmits the data transfer start request that was put on hold to one of the USB devices 201 to 203. In this way, the data transfer can be started.

As described above, in accordance with the second exemplary embodiment of the present invention, the above-described Dual-Role Device can refrain from performing data transfer with the peripheral device by the host function, for example, when the Dual-Role Device is performing data transfer with the host device by the peripheral function. By doing so, a larger amount of resources can be allocated to the data transfer processing in the peripheral function. Therefore, it is possible to provide a data transfer control device and a data transfer control method capable of maintaining the transfer performance of the peripheral function at a high level when the host function and the peripheral function are simultaneously performed.

### Third Exemplary Embodiment

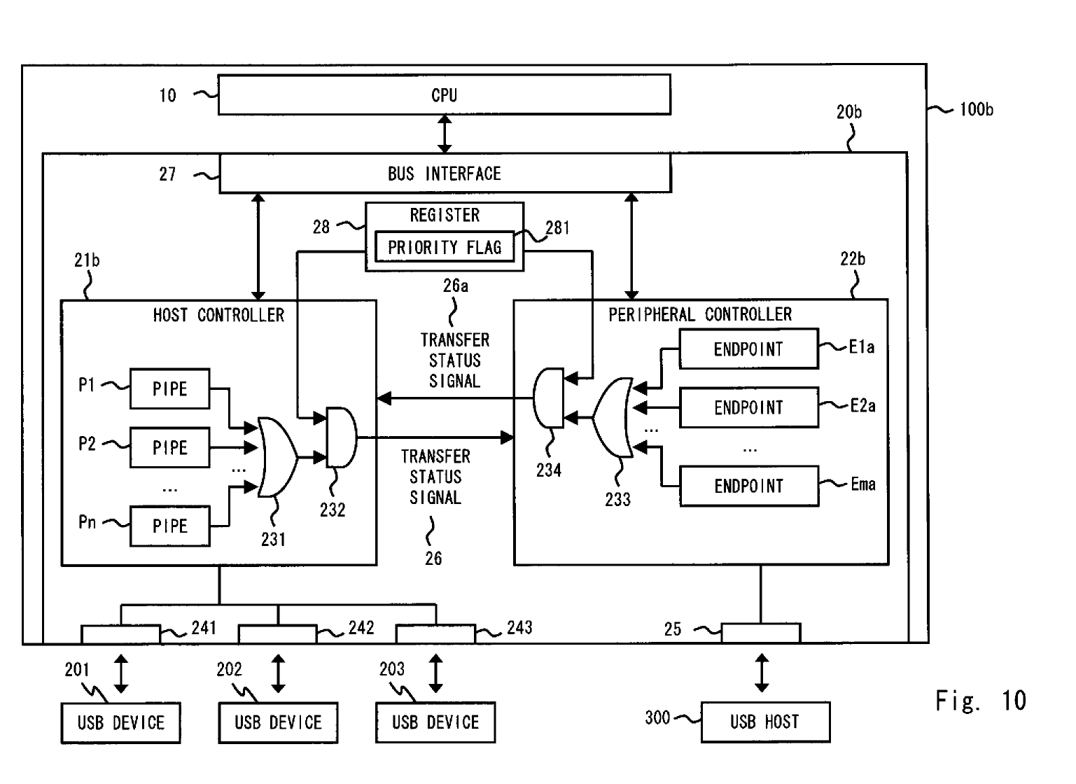

In a third exemplary embodiment in accordance with the present invention, a data transfer control device 100b is explained. The data transfer control device 100b can select in which of the host function and the peripheral function the transfer performance should be improved FIG. 10 is a block diagram showing the overall configuration of a data transfer control device 100b in accordance with the third exemplary embodiment of the present invention. Note that the data transfer control device 100b may be constructed by making some modifications to the above-described data transfer control device 100 or 100a. In FIG. 10, structures having similar functions to those of FIG. 1 or 8 are denoted by the same signs, and their detailed explanations are omitted in the following explanation. Further, the following explanation is made with particular emphasis on the differences from the first and second exemplary embodiments of the present invention.

The data transfer control device 100b includes a CPU 10 and a USB Dual-Role Device 20b. The USB Dual-Role Device 20b is a Dual-Role Device in conformity with the USB standards. The data transfer control device 100b accepts preferential function designation information (PRIORITY FLAG) 281 that specifies in which of the host function and the peripheral function the data transfer processing should have a higher priority from the outside, and performs data transfer processing with the USB devices 201 to 203 and with the USB host 300 based on the preferential function designation information 281.

The USB Dual-Role Device 20b includes a host controller 21b, a peripheral controller 22b, downstream ports 241 to 243, an upstream port 25, a bus interface 27, and a register 28.

The register 28 is a register that stores the above-described preferential function designation information 281. For example, the data transfer control device 100b may accept the preferential function designation information 281 from the outside and store the accepted preferential function designation information 281 in the register 28. Note that the preferential function designation information 281 is information used to control the function whose data transfer processing should have a higher priority. Alternatively, the preferential function designation information 281 can be also called “communication unit designation information” that is used to designate either the host controller 21b or the peripheral controller 22b as the communication unit whose data transfer should have a higher priority. Further, an example of the preferential function designation information 281 is shown hereinafter. For example, assume that the preferential function designation information 281 is expressed as 2-bit data. In such a case, if the higher-order bit is “1”, the transmission of a transfer status signal 26 from the host controller 21b to the peripheral controller 22b is permitted, whereas if the higher-order bit is “0”, the transmission of the transfer status signal 26 is not permitted. Further, if the lower-order bit is “1”, the transmission of a transfer status signal 26a from the peripheral controller 22b to the host controller 21b is permitted, whereas if the lower-order bit is “0”, the transmission of the transfer status signal 26a is not permitted. Note that the higher-order bit and the lower-order bit cannot be set to “1” at the same time. That is, in this example, when the preferential function designation information 281 is “10”, it indicates that the host controller 21b is designated as the communication unit whose data transfer should have a higher priority. Further, when the preferential function designation information 281 is “01”, it indicates that the peripheral controller 22b is designated as the communication unit whose data transfer should have a higher priority. Note that examples of the preferential function designation information 281 are not limited to this example.

The host controller 21b outputs a transfer status signal 26 to the peripheral controller 22b only when the host controller 21b itself is designated in the preferential function designation information 281. With regard to other functions, the host controller 21b has similar functions to those of the host controller 21.

Further, the peripheral controller 22b outputs a transfer status signal 26a to the host controller 21b only when the peripheral controller 22b itself is designated in the preferential function designation information 281. With regard to other functions, the peripheral controller 22b has similar functions to those of the peripheral controller 22.

That is, the host controller 21b notifies the peripheral controller 22b that the host controller 21b is performing data transfer with one of the USB devices 201 to 203 when data transfer is started between the host controller 21b and one of the USB devices 201 to 203 and the host controller 21b is designated as the communication unit whose data transfer should have a higher priority. Then, when the peripheral controller 22b is being notified that the host controller 21b is performing data transfer with one of the USB devices 201 to 203 from the host controller 21b, the peripheral controller 22b transmits a transfer disabled response indicating that data transfer cannot be performed to the USB host 300 in response to a data transfer start request from the USB host 300.

On the other hand, the peripheral controller 22b notifies the host controller 21b that the peripheral controller 22b is performing data transfer with the USB host 300 when data transfer is started between the peripheral controller 22b and the USB host 300 and the peripheral controller 22b is designated as the communication unit whose data transfer should have a higher priority. Then, when the host controller 21b is being notified that the peripheral controller 22b is performing data transfer with the USB host 300 from the peripheral controller 22b, the host controller 21b puts the transmission of a data transfer start request to one of the USB devices 201 to 203 on hold. Then, after the peripheral controller 22b has completed the data transfer with the USB host 300, the host controller 21b transmits the data transfer start request that was put on hold to one of the USB devices 201 to 203.

Further, the host controller 21b includes pipes P1, P2, . . . , and Pn, an OR circuit 231, and an AND circuit 232. The pipes P1, P2, . . . , and Pn have a similar configuration and functions to those shown in FIG. 1, and therefore the illustration and detailed explanation of the internal configuration is omitted. The OR circuit 231 combines transfer status signals output from the pipes P1, P2, . . . , and Pn into one transfer status signal, and outputs the one transfer status signal to the AND circuit 232 as a signal having an active level or an inactive level. The AND circuit 232 calculates the logical product of the signal input from the OR circuit 231 and the higher-order bit of preferential function designation information 281 stored in the register 28. Then, when the result of the logical product is “1”, the AND circuit 232 brings the transfer status signal 26 to “1” level and outputs the transfer status signal 26 having “1” level to the peripheral controller 22b. Further, when the result of the logical product is “0”, the host controller 21b brings the transfer status signal 26 to “0” level and outputs the transfer status signal 26 having “0” level to the peripheral controller 22b. Note that the OR circuit 231 and the AND circuit 232 may be constructed by making some modifications to the transmission unit 23 shown in FIG. 1.

That is, when the host controller 21b starts data transfer with one of the USB devices 201 to 203, the host controller 21b notifies whether the data transfer is being performed or not according to the preferential function designation information 281 stored in the register 28.

Further, the peripheral controller 22b includes endpoints E1a, E2a, . . . , and Ema, an OR circuit 233, and an AND circuit 234. The endpoints E1a, E2a, . . . , and Ema have a similar configuration and functions to those shown in FIG. 8, and therefore the illustration and detailed explanation of the internal configuration is omitted. The OR circuit 233 combines transfer status signals output from the endpoints E1a, E2a, . . . , and Ema into one transfer status signal, and outputs the one transfer status signal to the AND circuit 234 as a signal having an active level or an inactive level. The AND circuit 234 calculates the logical product of the signal input from the OR circuit 233 and the lower-order bit of preferential function designation information 281 stored in the register 28. Then, when the result of the logical product is “1”, the AND circuit 234 brings the transfer status signal 26 to “1” level and outputs the transfer status signal 26a having “1” level to the host controller 21b. Further, when the result of the logical product is “0”, the peripheral controller 22b brings the transfer status signal 26a to “0” level and outputs the transfer status signal 26 having “0” level to the host controller 21b. Note that the OR circuit 233 and the AND circuit 234 may be constructed by making some modifications to the transmission unit 23a shown in FIG. 8.

That is, when the peripheral controller 22b starts data transfer with the USB host 300, the peripheral controller 22b notifies whether the data transfer is being performed or not according to the preferential function designation information 281 stored in the register 28.

Further, the host controller 21b outputs the transfer status signal 26 as a transfer permission/denial signal, which is used to notify the permission/denial of data transfer between the peripheral controller 22b and the USB host 300, to that peripheral controller 22b according to the preferential function designation information 281. Then, the peripheral controller 22b enters the data transfer disabled mode, in which the peripheral controller 22b transmits a transfer disabled response in response to a data transfer start request from the USB host 300.

Meanwhile, the peripheral controller 22b notifies the host controller 21b that data transfer is being performed between the peripheral controller 22b and the USB host 300 according to the preferential function designation information 281 through the transfer status signal 26a. Then, when the host controller 21b receives an active transfer status signal 26a from the peripheral controller 22b, the host controller 21b temporarily puts the data transfer start request to the USB devices 201 to 203 on hold.

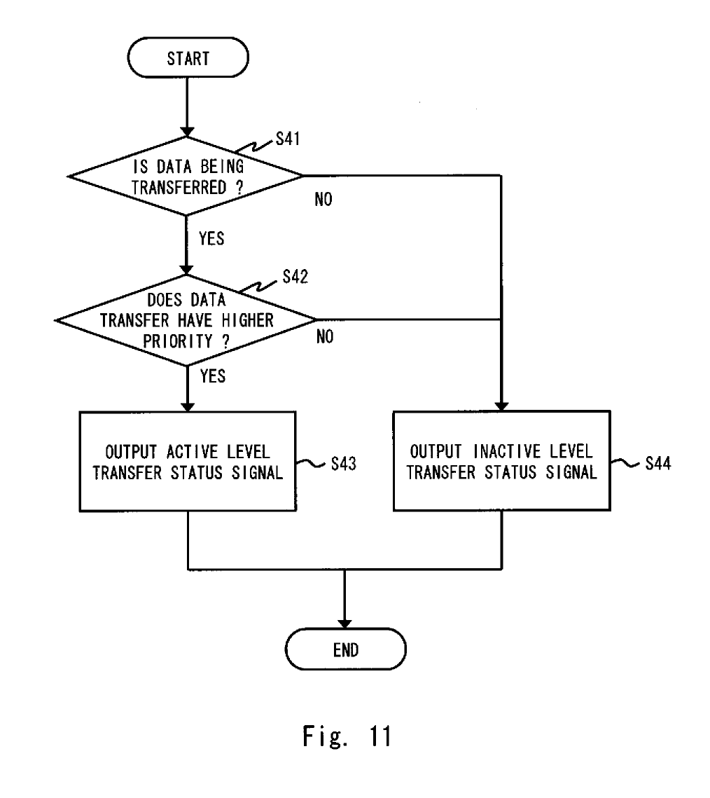

FIG. 11 is a flowchart showing a process flow of a host controller or a peripheral controller in accordance with the third exemplary embodiment of the present invention. Note that although only the peripheral controller 22b is explained in the following explanation, similar processing is also performed for the host controller 21b. Further, assume that “1” is stored in advance in each of the output control registers C1a and C2a in this example.

Firstly, the peripheral controller 22b determines whether data transfer is being performed or not (S41). For example, the OR circuit 233 calculates the logical sum of the transfer status signals output from the endpoints E1a, E2a, . . . , and Ema, and determines whether the result of the logical sum is “1” or not.

If the result of the logical sum is “1” in a step S41, the peripheral controller 22b determines whether the data transfer should have a higher priority or not (S42). For example, the AND circuit 234 calculates the logical product of a signal input from the OR circuit 233 and the lower-order bit of preferential function designation information 281 stored in the register 28, and determines whether the result of the logical product is “1” or not.

If the result of the logical product is “1” in a step S42, the AND circuit 234 outputs a transfer status signal 26a having an active level to the host controller 21b (S43). For example, when data transfer between the peripheral controller 22b and the USB host 300 is started, the endpoint E1a outputs “1” to the OR circuit 233 because “1” is stored in the status register S1a and “1” is stored in advance in the output control register C1a. In this case, the result of the logical sum becomes “1” irrespective of the output results from the endpoints E2a, . . . , and Ema. Further, when the preferential function designation information 281 is “01”, i.e., when the lower-order bit is “1”, the result of the logical product in the AND circuit 234 becomes “1”. That is, it is determined that the peripheral controller 22b is designated as the communication unit whose data transfer should have a higher priority. In this case, the AND circuit 234 brings the transfer status signal 26a to “1” level and outputs the transfer status signal 26a having “1” level to the host controller 21b.

Further, if the result of the logical product is “0” in the step S42, the AND circuit 234 outputs a transfer status signal 26a having an inactive level to the host controller 21b (S44). For example, when the preferential function designation information 281 is “10”, i.e., when the lower-order bit is “0”, the result of the logical product in the AND circuit 234 inevitably becomes “0” irrespective of the result of the logical sum in the OR circuit 233. That is, it is determined that the peripheral controller 22b is not designated as the communication unit whose data transfer should have a higher priority. In this case, the AND circuit 234 brings the transfer status signal 26a to “0” level and outputs the transfer status signal 26a having “0” level to the host controller 21b.

Further, if the result of the logical sum is “0” in the step S41, the AND circuit 234 outputs a transfer status signal 26a having an inactive level to the host controller 21b (S44). For example, when data transfer is not being performed between the peripheral controller 22b and the USB host 300, all of the output results supplied from the endpoints E1a, . . . , and Ema to the OR circuit 233 become “0” and therefore the result of the logical sum also becomes “0”. Therefore, even when the lower-order bit of the preferential function designation information 281 is “1”, the result of the logical product in the AND circuit 234 becomes “0”. In this case, the AND circuit 234 brings the transfer status signal 26a to “0” level and outputs the transfer status signal 26a having “0” level to the host controller 21b.

As described above, the third exemplary embodiment in accordance with the present invention can be expressed as an embodiment that is obtained by making some modifications to the host controller 21a according to the first exemplary embodiment and the peripheral controller 22a according to the second exemplary embodiment so that the register 28 in which preferential function designation information 281 is stored is added. Therefore, the output of the transfer status signal of either the host function or the peripheral function can be controlled according to the preferential function designation information 281. In this way, a user who uses the data transfer control device 100b can select which of the host function and the peripheral function should have a higher priority for its transfer performance. In particular, it becomes possible to switch the function whose transfer performance should have a higher priority in a flexible manner by updating the preferential function designation information 281 stored in the register 28 according to the types of devices used for the USB devices 201 to 203 and the USB host 300 connected to the data transfer control device 100b and/or the specific type of data transfer processing.

Further, even when a sophisticated USB peripheral device or USB host device having high transfer performance is developed, a desired function(s) become usable by connecting it to a USB Dual-Role Device having a data transfer control device 100b installed therein.

As described above, in accordance with the third exemplary embodiment of the present invention, data transfer processing can be performed while giving a higher priority to one of the host function and the peripheral function that can be arbitrarily designated. In this way, for example, a user who uses the above-described Dual-Role Device can select which function should have a higher priority in a flexible manner. Further, a data transfer control device and a data transfer control method capable of maintaining the transfer performance of a designated function at a high level when the host function and the peripheral function are simultaneously performed.

### Other Exemplary Embodiments

Note that the data transfer control device 100 in accordance with the first exemplary embodiment of the present invention may further include a state management register that holds a data transfer state between one of the USB devices 201 to 203 and the host controller 21. With such a configuration, when data transfer is started between one of the USB devices 201 to 203 and the USB host 300, the peripheral controller 22 may store information indicating that the data transfer is being performed in the state management register. Further, when the data transfer is completed, the peripheral controller 22 may clear the information stored in the state management register. In this way, the data transfer state and the load state can be acquired by software, and used for the debugging and/or analyzing.

Note that the peripheral controller 22 in accordance with the first exemplary embodiment of the present invention may administer the wait state of data transfer in the peripheral controller 22 itself by switching an internal flag (not shown) as data transfer in the host controller 21 is started or finished. In such a case, the peripheral controller 22 may perform control so as to switch the response to a data transfer start request from the USB host 300 according to the internal flag. Further, similar configuration may be also applied to the peripheral controller 22b in accordance with the third exemplary embodiment of the present invention.

Further, the host controller 21a in accordance with the second exemplary embodiment of the present invention may administer the wait state of data transfer in the host controller 21a itself by switching an internal flag (not shown) as data transfer in the peripheral controller 22a is started or finished. In such a case, the host controller 21a may perform control so as to change whether the transmission of a data transfer start request to the USB devices 201 to 203 should be put on hold or not according to the internal flag. Further, similar configuration may be also applied to the host controller 21b in accordance with the third exemplary embodiment of the present invention.

Note that the first to third exemplary embodiments in accordance with the present invention can be also expressed in the following way. That is, in a data transfer control device in accordance with first to third exemplary embodiments of the present invention: one of the host controller and the peripheral controller serves as a preferential communication unit whose data transfer should have a high priority, and the other of the host controller and the peripheral controller serves as a non-preferential communication unit; when data transfer is being performed in the preferential communication unit, the preferential communication unit notifies the non-preferential communication unit that the data transfer is being performed; and when the non-preferential communication unit is being notified that the data transfer is being performed from the preferential communication unit, the non-preferential communication unit puts data transfer in the non-preferential communication unit on hold.

Further, the first exemplary embodiment in accordance with the present invention shows an example in which the host controller 21 serves as the preferential communication unit and the peripheral controller 22 serves as the non-preferential communication unit in a fixed manner. Furthermore, it is also shown that the peripheral controller 22 puts data transfer with the USB host 300 on hold by transmitting a transfer disabled response.

Further, the second exemplary embodiment in accordance with the present invention shows an example in which the peripheral controller 22a serves as the preferential communication unit and the host controller 21a serves as the non-preferential communication unit in a fixed manner. Furthermore, it is also shown that the host controller 21a puts data transfer with one of the USB devices 201 to 203 on hold by putting the transmission of a data transfer start request to the USB devices 201 to 203 on hold.

Further, the third exemplary embodiment in accordance with the present invention shows an example in which the host controller 21b and the peripheral controller 22b can be externally designated as either the preferential communication unit or the non-preferential communication unit. Furthermore, the register 28 stores preferential function designation information 281 that designates either the host controller 21b or the peripheral controller 22b as the preferential communication unit.

Further, the present invention is not limited to the above-described exemplary embodiments, and needless to say, various modifications can be made without departing from the spirit and scope of the present invention described above. For example, although the present invention is explained as a hardware configuration in the above-described exemplary embodiments, the present invention is not limited to the hardware configuration. In the present invention, the processing to control the host controller 21 and the peripheral controller 22 can be also implemented by causing the CPU 10 to execute a computer program. In such a case, the computer program may monitor the data transfer state of the host controller 21, and may instruct the peripheral controller 22 to transmit a transfer disabled response when data transfer is being performed in the host controller 21. In this way, the data transfer processing performance of the host function can be maintained at a high level when the host function and the peripheral function are simultaneously performed.

Note that realizing the above-described computer program requires implementation of complicated processing. Therefore, when the CPU 10 executes such complicated processing, the processing load on the CPU 10 could be increased. In the above-described first exemplary embodiment in accordance with the present invention, the instruction for outputting a transfer disabled signal is implemented as a transfer status signal that is supplied from the host controller 21 to the peripheral controller 22 without requiring the intervention of the CPU 10. In this way, the processing load on the CPU 10 is further reduced.

Further, the present invention is not limited to the above-described exemplary embodiments, and needless to say, various modifications can be made without departing from the spirit and scope of the present invention described above.

The whole or part of the exemplary embodiments disclosed above can be described as, but not limited to, the following supplementary notes.

(Supplementary note 1) A data transfer control device including:

a first communication unit that processes data transfer with a peripheral device; and

a second communication unit that processes data transfer with a host device,

wherein when the second communication unit is being notified that the first communication unit is performing data transfer with the peripheral device from the first communication unit, the second communication unit transmits a transfer disabled response indicating that data transfer to the host device cannot be performed in response to a data transfer start request from the host device.

(Supplementary note 2) The data transfer control device recited in Supplementary note 1, wherein

when data transfer between the first communication unit and the peripheral device is started and the first communication unit is designated as a communication unit whose data transfer should have a higher priority, the first communication unit notifies the second communication unit that the first communication unit is performing data transfer with the peripheral device,

when data transfer between the second communication unit and the host device is started and the second communication unit is designated as a communication unit whose data transfer should have a higher priority, the second communication unit notifies the first communication unit that the second communication unit is performing data transfer with the host device, and

when the first communication unit is being notified that the second communication unit is performing data transfer with the host device from the second communication unit, the first communication unit puts transmission of a data transfer start request to the peripheral device on hold; and after the second communication unit has completed the data transfer with the host device, the first communication unit transmits the data transfer start request that was put on hold to the peripheral device.

(Supplementary note 3) The data transfer control device recited in Supplementary note 2, further comprising a register that stores communication unit designation information designating either the first communication unit or the second communication unit as a communication unit whose data transfer should have a higher priority,

wherein when the data transfer is started, the first communication unit or the second communication unit notifies whether the data transfer is being performed or not according to the communication unit designation information stored in the register.

(Supplementary note 4) The data transfer control device recited in Supplementary note 3, wherein

the first communication unit outputs a transfer permission/denial signal used to notify permission/denial of data transfer between the second communication unit and the host device to the second communication unit according to the communication unit designation information,

the second communication unit enters a data transfer disabled mode, in which the transfer disabled response is transmitted in response to a data transfer start request from the host device, according to the transfer permission/denial signal,

the second communication unit outputs a transfer hold request signal to the first communication unit according to the communication unit designation information, the transfer hold request signal being used to notify a request for putting data transfer between the first communication unit and the peripheral device on hold, and

the first communication unit enters a data transfer hold mode, in which a data transfer start request to the peripheral device is put on hold, according to the transfer hold request signal.

(Supplementary note 5) A data transfer control device including:

a first communication unit that processes data transfer with a peripheral device; and

a second communication unit that processes data transfer with a host device,

wherein when the first communication unit is being notified that the second communication unit is performing data transfer with the host device from the second communication unit, the first communication unit puts transmission of a data transfer start request to the peripheral device on hold; and after the second communication unit has completed the data transfer with the host device, the first communication unit transmits the data transfer start request that was put on hold to the peripheral device.

(Supplementary note 6) The data transfer control device recited in Supplementary note 5, wherein

data transfer between the peripheral device and the first communication unit and data transfer between the host device and the second communication unit are transfer based on USB (Universal Serial Bus) standards, and

the first communication unit puts transmission of the data transfer start request on hold in bulk transfer or control transfer.

(Supplementary note 7) A data transfer control method to control a data transfer control device including a first communication unit that processes data transfer with a peripheral device, and a second communication unit that processes data transfer with a host device, wherein
when data transfer between the first communication unit and the peripheral device is started in the first communication unit, the second communication unit is notified that the first communication unit is performing data transfer with the peripheral device, and
when the second communication unit is being notified that the first communication unit is performing data transfer with the peripheral device from the first communication unit, a transfer disabled response indicating that data transfer to the host device cannot be performed is transmitted in response to a data transfer start request from the host device.

(Supplementary note 8) A data transfer control method to control a data transfer control device including a first communication unit that processes data transfer with a peripheral device, and a second communication unit that processes data transfer with a host device, wherein
when data transfer between the second communication unit and the host device is started in the second communication unit, the first communication unit is notified that the second communication unit is performing data transfer with the host device, and
when the first communication unit is being notified that the second communication unit is performing data transfer with the host device from the second communication unit, transmission of a data transfer start request to the peripheral device is put on hold; and after the second communication unit has completed the data transfer with the host device, the data transfer start request that was put on hold is transmitted to the peripheral device.

(Supplementary note 9) A data transfer control method to control a data transfer control device including a first communication unit that processes data transfer with a peripheral device, and a second communication unit that processes data transfer with a host device, wherein

when data transfer between the first communication unit and the peripheral device is started in the first communication unit and the first communication unit is designated as a communication unit whose data transfer should have a higher priority, the second communication unit is notified that the first communication unit is performing data transfer with the peripheral device,

when the second communication unit is being notified that the first communication unit is performing data transfer with the peripheral device from the first communication unit, a transfer disabled response indicating that data transfer to the host device cannot be performed is transmitted in response to a data transfer start request from the host device,

when data transfer between the second communication unit and the host device is started in the second communication unit and the second communication unit is designated as a communication unit whose data transfer should have a higher priority, the first communication unit is notified that the second communication unit is performing data transfer with the host device, and

when the first communication unit is being notified that the second communication unit is performing data transfer with the host device from the second communication unit, transmission of a data transfer start request to the peripheral device is put on hold; and after the second communication unit has completed the data transfer with the host device, the data transfer start request that was put on hold is transmitted to the peripheral device.

The first, second and third exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A data transfer control device comprising:
a first communication unit that processes data transfer with a peripheral device; and
a second communication unit that processes data transfer with a host device, wherein
one of the first and second communication units serves as a preferential communication unit whose data transfer should have a high priority, and another of the first and second communication units serves as a non-preferential communication unit,
when the data transfer is being performed in the preferential communication unit, the preferential communication unit notifies the non-preferential communication unit that the data transfer is being performed, and
when the non-preferential communication unit is being notified that the data transfer is being performed from the preferential communication unit, the non-preferential communication unit puts the data transfer in the non-preferential communication unit on hold.

2. The data transfer control device according to claim 1, further comprising a register that stores communication unit designation information designating either the first communication unit or the second communication unit as the preferential communication unit,
wherein when the data transfer is started, the first communication unit and the second communication unit notify whether the data transfer is being performed or not according to the communication unit designation information stored in the register.

3. The data transfer control device according to claim 1, wherein
the first communication unit itself is the preferential communication unit; and when data transfer is started between the first communication unit itself and the peripheral device, the first communication unit notifies the second communication unit that data transfer with the peripheral device is being performed, and
when second communication unit is being notified that the first communication unit is performing data transfer with the peripheral device from the first communication unit, the second communication unit transmits a transfer disabled response indicating that data transfer to the host device cannot be performed in response to a data transfer start request from the host device.

4. The data transfer control device according to claim 3, wherein when data transfer between the peripheral device and the first communication unit is started during data transfer between the second communication unit and the host device, the second communication unit transmits the transfer disabled response in response to the data transfer start request that is sent from the host device when or after current data transfer is completed.

5. The data transfer control device according to claim 3, wherein
the first communication unit outputs a transfer permission/denial signal used to notify permission/denial of data transfer between the second communication unit and the host device to the second communication unit, and
the second communication unit enters a data transfer disabled mode, in which the transfer disabled response is transmitted in response to a data transfer start request from the host device, according to the transfer permission/denial signal.

6. The data transfer control device according to claim 1, wherein
the second communication unit itself is the preferential communication unit; and when data transfer is started between the second communication unit itself and the host device, the second communication unit notifies the first communication unit that data transfer with the host device is being performed, and
when the first communication unit is being notified that the second communication unit is performing data transfer with the host device from the second communication unit, the first communication unit puts transmission of a data transfer start request to the peripheral device on hold; and when the first communication unit is being notified that the second communication unit has completed the data transfer with the host device, the first communication unit transmits the data transfer start request that was put on hold to the peripheral device.

7. The data transfer control device according to claim 6, wherein when data transfer between the host device and the second communication unit is started during data transfer between the first communication unit and the peripheral device, the first communication unit puts transmission of the data transfer start request to the peripheral device that is to be performed when or after current data transfer is completed on hold.

8. The data transfer control device according to claim 6, wherein
the second communication unit outputs a transfer hold request signal to the first communication unit, the transfer hold request signal being used to notify a request for putting data transfer between the first communication unit and the peripheral device on hold, and
the first communication unit enters a data transfer hold mode, in which a data transfer start request to the peripheral device is put on hold, according to the transfer hold request signal.

9. The data transfer control device according to claim 5, wherein
the first communication unit comprises a plurality of transfer execution units each of which performs data transfer with a respective one of a plurality of endpoints of the peripheral device,
the first communication unit transmits the transfer permission/denial signal set to an active state to the second communication unit from when data transfer with the peripheral device is started in one of the plurality of transfer execution units to when the data transfer is finished in all transfer execution units that have been performing data transfer with the peripheral device, and
the second communication unit enters the data transfer disabled mode when the transfer permission/denial signal is an active state.

10. The data transfer control device according to claim 9, each of the plurality of transfer execution units comprises a notification determination unit that determines whether or not a situation where data transfer is being performed with the peripheral device should be notified to the second communication unit,
the first communication unit transmits the transfer permission/denial signal set to an active state to the second communication unit when there is a transfer execution unit, among transfer execution units that are performing data transfer with the peripheral device, that is determined to be notified to the second communication unit by the notification determination unit, and
the second communication unit enters the data transfer disabled mode when the transfer permission/denial signal is an active state.

11. The data transfer control device according to claim 9,
when transmission to the second communication unit for which the transfer permission/denial signal is brought to an active state has continued for a predetermined time or longer, the first communication unit sets the transfer permission/denial signal to an inactive state and transmits the inactive transfer permission/denial signal to the second communication unit, and
the second communication unit enters a mode other than the data transfer disabled mode when the transfer permission/denial signal is an inactive state.

12. The data transfer control device according to claim 3,
data transfer between the peripheral device and the first communication unit and data transfer between the host device and the second communication unit are transfer based on USB (Universal Serial Bus) standards, and
when the second communication unit receives an IN, OUT, or PING token from the host device in bulk transfer or interrupt transfer, the second communication unit sends back a NAK (Negative AcKnowledgement) response.

13. The data transfer control device according to claim 1, further comprising a state management register that holds a data transfer state between the peripheral device and the first communication unit,
wherein when data transfer is started between the peripheral device and the first communication unit, the second communication unit stores information indicating that data transfer is being performed in the state management register; and when the data transfer is completed, the second communication unit clears the information stored in the state management register.

14. The data transfer control device according to claim 8, wherein
the second communication unit comprises a plurality of endpoints each of which performs data transfer with a respective one of a plurality of transfer execution units of the host device,
the second communication unit transmits the transfer hold request signal set to an active state to the first communication unit from when data transfer with the host device is started in one of the plurality of endpoints to when the data transfer is finished in all endpoints that have been performing data transfer with the host device, and
the first communication unit enters the data transfer hold mode when the transfer hold request signal is an active state.

15. The data transfer control device according to claim 14, each of the plurality of endpoints comprises a notification determination unit that determines whether or not a situation where data transfer is being performed with the host device should be notified to the first communication unit,
the second communication unit transmits the transfer hold request signal set to an active state to the first communication unit when there is an endpoint, among endpoints that are performing data transfer with the host device, that is determined to be notified to the first communication unit by the notification determination unit, and
the first communication unit enters the data transfer hold mode when the transfer hold request signal is an active state.

16. A data transfer control method to control a data transfer control device comprising a first communication unit that processes data transfer with a peripheral device, and a second communication unit that processes data transfer with a host device, wherein
one of the first and second communication units serves as a preferential communication unit whose data transfer should have a high priority, and another of the first and second communication units serves as a non-preferential communication unit,
when the data transfer is being performed in the preferential communication unit, the preferential communication unit notifies the non-preferential communication unit that the data transfer is being performed, and
when the non-preferential communication unit is being notified that the data transfer is being performed from the preferential communication unit, the non-preferential communication unit puts the data transfer in the non-preferential communication unit on hold.

17. The data transfer control method according to claim 16,
wherein the data transfer control device further comprises a register that stores communication unit designation information designating either the first communication unit or the second communication unit as the preferential communication unit,
the data transfer control device externally accepts communication unit designation information designating either the first communication unit or the second communication unit as a communication unit whose data transfer should have a higher priority, and stores the accepted communication unit designation information in a register,
when data transfer between the first communication unit and the peripheral device is started, the first communication unit notifies the second communication unit of whether or not the first communication unit is performing data transfer with the peripheral device according to the communication unit designation information stored in the register, and
when data transfer between the second communication unit and the host device is started, the second communication unit notifies the first communication unit of whether or not the second communication unit is performing data transfer with the host device according to the communication unit designation information stored in the register.

18. The data transfer control method according to claim 16, wherein
the first communication unit itself is the preferential communication unit; and when data transfer is started between the first communication unit itself and the peripheral device, the first communication unit notifies the second communication unit that the first communication unit is performing data transfer with the peripheral device,
when second communication unit is being notified that the first communication unit is performing data transfer with the peripheral device from the first communication unit, the second communication unit transmits a transfer disabled response indicating that data transfer to the host device cannot be performed in response to a data transfer start request from the host device,
the first communication unit itself is the preferential communication unit; and when data transfer between the first communication unit itself and the peripheral device is completed, the first communication unit notifies the second communication unit that the first communication unit has completed the data transfer with the peripheral device, and
when second communication unit is being notified that the first communication unit has completed the data transfer with the peripheral device from the first communication unit, the second communication unit transmits a response in response to a data transfer start request from the host device, the response being used to start data transfer with the host device.

19. The data transfer control method according to claim 16, wherein
the second communication unit itself is the preferential communication unit; and when data transfer is started between the second communication unit itself and the host device, the second communication unit notifies the first communication unit that the second communication unit is performing data transfer with the host device,
when first communication unit is being notified that the second communication unit is performing data transfer with the host device from the second communication unit, the first communication unit puts transmission of a data transfer start request to the peripheral device on hold,
the second communication unit itself is the preferential communication unit; and when data transfer between the second communication unit itself and the host device is completed, the second communication unit notifies the first communication unit that the second communication unit has completed the data transfer with the host device, and
when first communication unit is being notified that the second communication unit has completed the data transfer with the host device from the second communication unit, the first communication unit transmits the data transfer start request that was put on hold to the peripheral device.

20. The data transfer control method according to claim 17, wherein
the first communication unit outputs a transfer permission/denial signal used to notify permission/denial of data transfer between the second communication unit and the host device to the second communication unit according to the communication unit designation information,
the second communication unit enters a data transfer disabled mode, in which the transfer disabled response is transmitted in response to a data transfer start request from the host device, according to the transfer permission/denial signal,
the second communication unit outputs a transfer hold request signal to the first communication unit according to the communication unit designation information, the transfer hold request signal being used to notify a request for putting data transfer between the first communication unit and the peripheral device on hold, and
the first communication unit enters a data transfer hold mode, in which a data transfer start request to the peripheral device is put on hold, according to the transfer hold request signal.
